(19) United States
(12) Patent Application Publication
(10) Pub. No.: US 2005/0031422 A1
(43) Pub. Date: Feb. 10, 2005

(54) Cutter assembly

(76) Inventor: Ming-Lang Tseng, Changhwa Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/633,529

(22) Filed: Aug. 5, 2003

(51) Int. Cl. B23B 51/04

(52) U.S. Cl. 408/204; 408/206

(57) ABSTRACT

A cutter assembly has an adapter, a cutter body, a central drill and two positioning screws. The cutter body is detachably attached to the adapter. A first facet is defined in the outer periphery of the post. A cylindrical saw is formed on and extends from the bottom of the base. The central drill is detachably mounted on the adapter and extends through the cutter body. A second facet is defined in the outer periphery of the central drill. The positioning screws are screwed into the adapter and respectively abut against the facets on the cutter body and the central drill. With such an arrangement, the cutter body can be easily detached from the adapter when the cutter body is damaged or worn.

### BACKGROUND OF THE INVENTION

1. Field of the Invention

The present invention relates to a cutter assembly, and more particularly to a cutter assembly which has disposable components.

2. Description of Related Art

With reference to FIG. 4, a cylindrical cutter is used to drill a through hole in a material such as a metal plate when the diameter of the hole required is too great for the available drill bits. A cylindrical cutter in accordance with the prior art comprises an adapter (50) and a central drill (52). The adapter (50) is connected to a rotating machine such as an electric drill and is actuated to rotate by the rotating machine. A cylindrical saw (51) is integrally formed on the bottom of the adapter (50) to drill a through hole in a material such as a metal plate. The central drill (52) is detachably mounted in the bottom of the adapter (50) and extends out from the saw (51). To assemble the central drill (52) to the adapter (50), a central hole (not numbered) is defined in the bottom of the adapter (50) for one end of the central drill (52) to be securely received in the central hole. A threaded hole (not numbered) is defined in the adapter (50) and communicates with the central hole. A positioning screw (53) is screwed through the threaded hole and abuts against the central drill (52) to securely position the central drill (52) relative to the adapter (50) and to make the central drill (52) rotate with the adapter (50).

In operation, the central drill (52) will drill a small hole in the metal plate firstly. Then, the saw (51) will drill a through hole with a desired diameter in the metal plate and coaxial with the central drill (52). With the arrangement of the central drill (52), the through hole will be defined in the metal plate at a precisely predetermined position.

However, because the saw (51) is integrally formed on the adapter (50) of the conventional cutter, another cutter with a saw having a different diameter is needed when a through hole with a different diameter is to be cut which involves excessive stocks if a user is to be prepared for different work pieces. In addition, when the saw (51) is worn, the whole adapter (50) with the saw (51) must be replaced with a new one, which is wasteful in material.

With reference to FIG. 5, another conventional cutter in accordance with the prior art comprises an adapter (60), a cutter body (62) and a central drill (63). A threaded portion (61) is formed on the bottom end of the adapter (60), and the cutter body (62) has an inner threaded hole (not numbered) screwed with the threaded portion (61) on the adapter (60). A saw (not numbered) is formed on the cutter body (62). The central drill (63) extends through the cutter body (62) and into the adapter (60). A positioning screw (64) is screwed through a threaded hole (not numbered) defined in the adapter (60) and abuts against the central drill (63) to position the central drill (63) relative to the adapter (60). When the saw has become worn, the cutter body (62) can be detached from the adapter (60) and replaced with a new one.

However, the threaded portion (61) on the adapter (60) and the inner threaded hole in the cutter body (62) must bear a significant load during the operation of the cutter and are easily damaged. When the threads have become damaged, to disengage the cutter body (62) from the adapter (60) is difficult or even impossible.

To overcome the shortcomings, the present invention tends to provide a cutter assembly to mitigate or obviate the aforementioned problems.

### SUMMARY OF THE INVENTION

The main objective of the invention is to provide a cutter assembly that allows easy detachment of a cutter body from an adapter when the cutter body has been damaged. The cutter assembly has an adapter, a cutter body, a central drill and two positioning screws. The adapter has a hole with a bottom defined in the bottom of the adapter and a drill hole co-axially defined in the bottom of the hole. The cutter body is detachably attached to the adapter and has a base, a post and a cylindrical saw. The post extends from the top of the base and is received in the hole in the adapter. A first facet is defined in the outer periphery of the post. The saw is formed on and extends from the bottom of the base. The central drill is detachably mounted on the adapter and extends through the cutter body. The central drill has a second facet defined in the outer periphery of the central drill. The positioning screws are screwed into the adapter and respectively abut against the facets on the cutter body and the central drill.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a cutter assembly in accordance with the present invention;

FIG. 2 is an exploded perspective view of the cutter assembly in FIG. 1;

FIG. 3 is a side plan view in partial cross section of the cutter assembly in FIG. 1;

FIG. 4 is a side plan view in partial cross section of a conventional cutter in accordance with the prior art; and

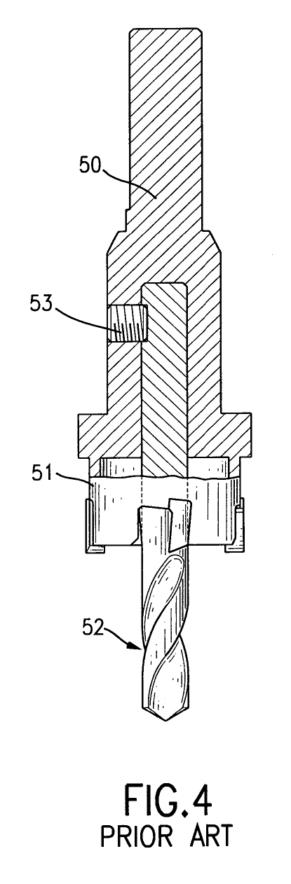

FIG. 5 is an exploded perspective view of another conventional cutter in accordance with the prior art.

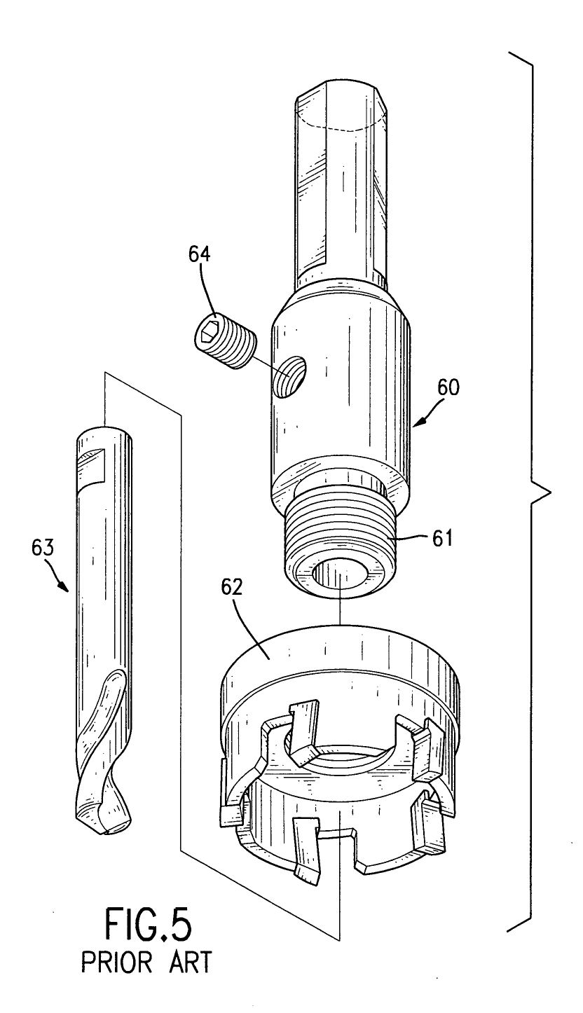

### DETAILED DESCRIPTION OF PREFERRED EMBODIMENT

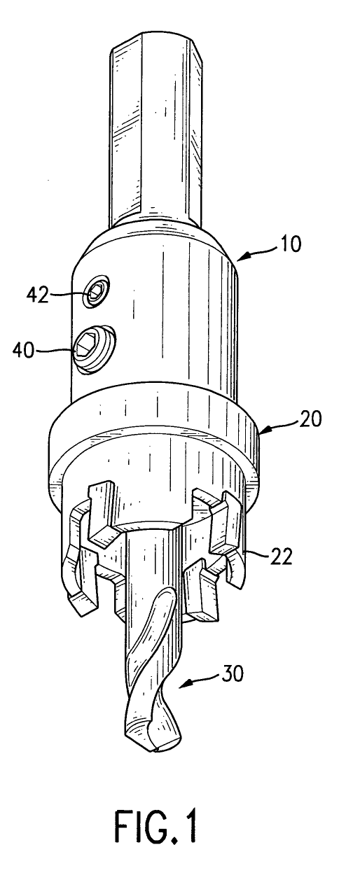

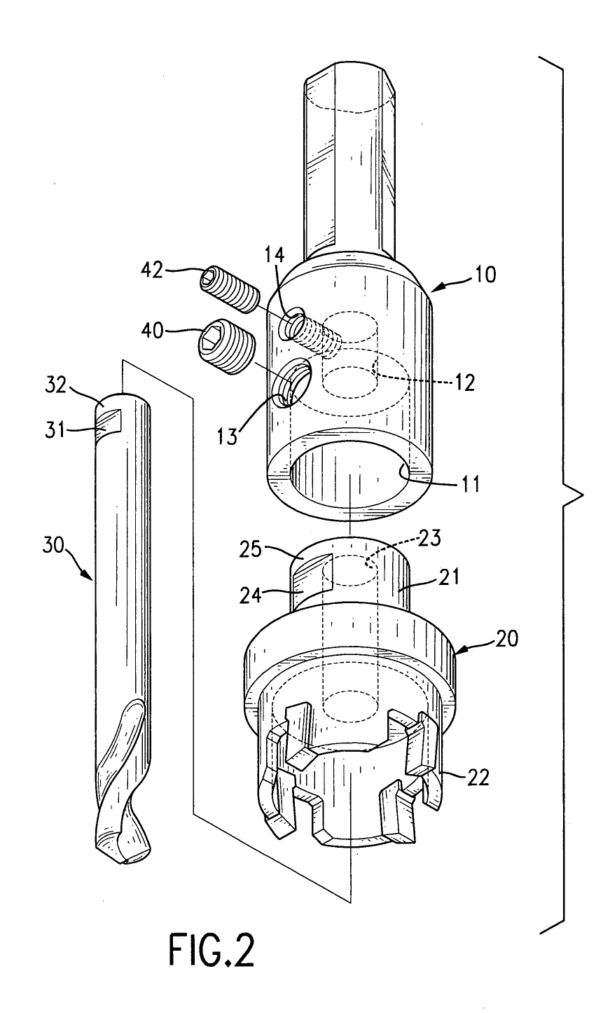

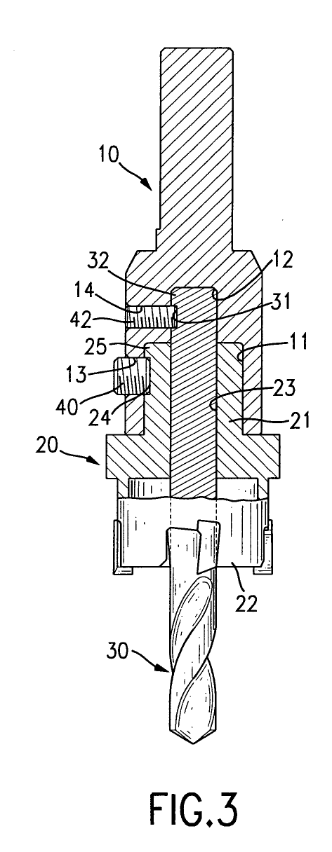

With reference to FIGS. 1 to 3, a cutter assembly in accordance with the prior art comprises an adapter (10), a cutter body (20), a central drill (30) and two positioning screws (40,42). The adapter (10) is used to connect to a rotating machine (not shown) and is actuated to rotate by the rotating machine. The adapter (10) has a bottom, an outer surface, a cutter hole (11), a drill hole (12), a first threaded hole (13) and a second threaded hole (14). The cutter hole (11) is defined in the bottom of the adapter (10) and a wall defines a bottom of the cutter hole (11). The drill hole (12) is defined in the wall defining the bottom of the cutter hole (11) and is co-axial with the cutter hole (11). The threaded holes (13,14) are defined in the outer surface of the adapter (10) and respectively communicate with the cutter hole (11) and the drill hole (12).

The cutter body (20) is detachably attached to the adapter (10) and has a base (not numbered), a post (21), a central hole (23) and a cylindrical saw (22). The post (21) extends from the top of the base and is received in the cutter hole (11) in the adapter (10). The post (21) has a first facet (24) defined in the outer periphery of the post (21), and a first stop (25) is formed on the post (21) adjacent to the first facet (24). The central hole (23) is axially defined through the post (21) and the base. The cylindrical saw (22) is formed on and extends from the bottom of the base. The central drill (30) is detachably mounted on the adapter (10) and extends through the central hole (23) in the cutter body (20). The central drill (30) has a first end extending through the central hole (23) in the cutter body (20) and received in the drill hole (12) in the adapter (10). The central drill (30) has a second facet (31) defined in the outer periphery of the central drill (30) near the first end to form a second stop (32) adjacent to the second facet (31).

The positioning screws (40,42) comprise a first positioning screw (40) and a second positioning screw (42). The first positioning screw (40) is screwed through the first threaded hole (13) in the adapter (10) and has a free end abutting against the first facet (24) on the cutter body (20). The second positioning screw (42) is screwed through the second threaded hole (14) in the adapter (10) and has a free end abutting against the second facet (31) on the central drill (30). The free ends of the positioning screws (40,42) respectively abut against the stops (25,32) on the cutter body (20) and the central drill (30). With the arrangement of the positioning screws (40,42), the cutter body (20) and the central drill (30) are securely attached to and rotate with the adapter (10). Additionally, with the abutments between the positioning screws (40,42) and stops (25,32), the cutter body (20) and the central drill (30) can be kept from escaping from the hole (11) and drill hole (12) in the adapter (10).

In such a cutter assembly, the direction of threads of the threaded holes (13,14) and the positioning screws (40,42) are perpendicular to the rotating direction of the cutter assembly. Accordingly, the threads of the positioning screws (40,42) and the threaded holes (13,14) in the adapter (10) will not bear a load during the operation of the cutter. The positioning screws (40,42) are not easily damaged, and the useful life of the cutter assembly is prolonged. In addition, when the cylindrical saw (22) on the cutter body (20) becomes worn, the cutter body (20) can be easily detached from the adapter (10). Accordingly, waste in material is prevented.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cutter assembly comprising:
an adapter with a bottom and an outer surface having:
a cutter hole defined in the bottom of the adapter and partly defined by a bottom face;
a drill hole defined in the bottom face defining the cutter hole and co-axial with the cutter hole;
a first threaded hole defined in the outer surface of the adapter and communicating with the cutter hole; and
a second threaded hole defined in the outer surface of the adapter and communicating with the drill hole;
a cutter body detachably attached to the adapter and having
a base with a top and a bottom;
a post with an outer periphery extending from the top of the base and received in the cutter hole in the adapter and having a first facet defined in the outer periphery of the post;
a central hole axially defined through the post and the base; and
a cylindrical saw formed on and extending from the bottom of the base;
a central drill with an outer periphery detachably mounted on the adapter and extending through the central hole in the cutter body and having
a first end extending through the central hole in the cutter body and received in the drill hole in the adapter; and
a second facet defined in the outer periphery of the central drill near the first end;
a first positioning screw screwed through the first threaded hole in the adapter and having a free end abutting against the first facet on the cutter body; and
a second positioning screw screwed through the second threaded hole in the adapter and having a free end abutting against the second facet on the central drill.

2. The cutter assembly as claimed in claim 1 further comprising a first stop formed on the post of the cutter body adjacent to the first facet to abut against the free end of the first positioning screw.

3. The cutter assembly as claimed in claim 1 further comprising a second stop formed on the central drill adjacent to the second facet to abut against the free end of the second positioning screw.
